(19) United States
(12) Patent Application Publication
(10) Pub. No.: US 2008/0239182 A1
(43) Pub. Date: Oct. 2, 2008

(54) Multi-domain vertical alignment liquid crystal display

(75) Inventors: Shang-Yu Huang, Miao-Li (TW); Tsau-Hua Hsieh, Miao-Li (TW); Hung-Yu Chen, Miao-Li (TW); Chao-Yi Hung, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/080,343

(22) Filed: Apr. 2, 2008

(30) Foreign Application Priority Data
Apr. 2, 2007 (TW) 96111568

(51) Int. Cl. G02F 1/133; G02F 1/1368

(52) U.S. Cl. 349/38; 349/42; 349/33; 349/144

(57) ABSTRACT

An exemplary multi-domain vertical alignment liquid crystal display (200) includes a plurality of gate lines (201) configured for providing a plurality of scanning signals and a plurality of data lines (203) configured for providing a plurality of gray scale voltages. The gate lines and data lines cooperatively define a plurality of pixel regions (230) in a matrix. Each pixel region includes a first pixel electrode (213) and a second pixel electrode (223). The first and second pixel electrodes are applied with different gray scale voltages.

### FIELD OF THE INVENTION

The present invention relates to vertical alignment liquid crystal displays (LCDs), and particularly to an eight-domain vertical alignment liquid crystal display having two different sub-pixels in each pixel thereof.

### GENERAL BACKGROUND

Since liquid crystal displays are thin and light, consume relatively little electrical power, and do not cause flickering like in cathode ray tube (CRT) displays, they have helped spawn product markets such as laptop personal computers. In recent years, there has also been great demand for liquid crystal displays to be used as computer monitors and even televisions, both of which are typically larger than the liquid crystal displays of laptop personal computers. Such large-sized liquid crystal displays in particular require that an even brightness and contrast ratio prevail over the entire display surface, regardless of observation angle.

Because the conventional twisted nematic (TN) mode liquid crystal display cannot easily satisfy these demands, a variety of improved liquid crystal displays have recently been developed. They include in-plane switching (IPS) mode liquid crystal displays, optical compensation TN mode liquid crystal displays, and multi-domain vertical alignment (MVA) mode liquid crystal displays. In multi-domain vertical alignment mode liquid crystal displays, each pixel is divided into multiple regions. Liquid crystal molecules of the pixel are vertically aligned when no voltage is applied, and are inclined in different directions when a voltage is applied.

In a typical 4-domain vertical alignment mode liquid crystal display, each pixel is divided into 4 regions by a plurality of V-shaped protrusions disposed in two opposite substrates. The liquid crystal molecules of the pixel are inclined into four different directions when a voltage is applied. However, because a major axis and a minor axis of each liquid crystal molecule have different refractive indexes, and the liquid crystal molecules are all inclined at a same angle with respect to each of the substrates, a color shift phenomenon occurs when the 4-domain vertical alignment mode liquid crystal display is viewed from different locations. Therefore, in order to reduce the color shift of the 4-domain vertical alignment mode liquid crystal display, the 8-domain vertical alignment mode liquid crystal display has been developed. The 8-domain vertical alignment mode liquid crystal display is substantially formed by dividing each pixel of the 4-domain vertical alignment mode liquid crystal display into two sub-pixels. The two sub-pixels of each pixel have different voltages applied thereto, such that the liquid crystal molecules of the two sub-pixels are inclined at different angles with respect to each of the substrates. Therefore, the 8-domain vertical alignment mode liquid crystal display can reduce a color shift of displayed images compared to the 4-domain vertical alignment mode liquid crystal display.

Referring to FIG. 4 and FIG. 5, a typical multi-domain vertical alignment mode liquid crystal display 100 includes a plurality of gate lines 101 parallel to each other, a plurality of first data lines 103 parallel to each other and intersecting with the gate lines 101, a plurality of second data lines 105 parallel to the first data lines 103, a plurality of first thin film transistors (TFTs) 111 disposed in the vicinity of respective points of intersection of the gate lines 101 and the first data lines 103, a plurality of second TFTs 121 disposed in the vicinity of respective points of intersection of the gate lines 101 and the second data lines 105, a plurality of first pixel electrodes 113, a plurality of second pixel electrodes 123, a plurality of common electrodes 107 corresponding to the first pixel electrodes 113 and the second pixel electrodes 123, a plurality of first capacitors 115, and a plurality of second capacitors 125.

Each of the first TFTs 111 includes a gate electrode (not labeled) connected to a corresponding gate line 101, a source electrode (not labeled) connected to a corresponding first data line 103, and a drain electrode (not labeled) connected to a corresponding first pixel electrode 113. Each of the second TFTs 121 includes a gate electrode (not labeled) connected to a corresponding gate line 101, a source electrode (not labeled) connected to a corresponding second data line 105, and a drain electrode (not labeled) connected to a corresponding second pixel electrode 123.

Each first pixel electrode 113 and the corresponding common electrode 107 constitute a first liquid crystal capacitor 117. Each second pixel electrode 123 and the corresponding common electrode 107 constitute a second liquid crystal capacitor 127. The first liquid crystal capacitor 117 and the first capacitor 115 are connected in parallel. The second liquid crystal capacitor 127 and the second capacitor 125 are connected in parallel.

One first TFT 111, the corresponding first capacitor 115, and the corresponding first liquid crystal capacitor 117 cooperatively define a first sub-pixel 110. One second TFT 121, the corresponding second capacitor 125, and the corresponding second liquid crystal capacitor 127 cooperatively define a second sub-pixel 120. The first and second sub-pixels 110, 120 cooperatively constitute a pixel 130. In another aspect, each pixel 130 is a region substantially defined by two adjacent gate lines 101 crossing over a first data line 103 and an adjacent second data line 105.

The gate lines 101 are configured for applying a plurality of scanning signals to the first and second TFTs 111, 121 in order to switch on or switch off the corresponding first and second TFTs 111, 121. The first data lines 103 are configured for applying a plurality of first gray scale voltages to the first TFTs 111. The second data lines 105 are configured for applying a plurality of second gray scale voltages to the second TFTs 121. Thus the first sub-pixels 110 and the second sub-pixels 120 have the first and second gray scale voltages applied thereto, respectively.

Because each pixel 130 includes one first TFT 111 and one second TFT 121, the structure of the liquid crystal display 100 is complicated, and the cost of the liquid crystal display 100 is correspondingly high.

What is needed, therefore, is a multi-domain vertical alignment LCD that can overcome the above-described deficiencies.

### SUMMARY

An exemplary multi-domain vertical alignment mode liquid crystal display includes a plurality of gate lines configured for providing a plurality of scanning signals and a plurality of data lines configured for providing a plurality of gray scale voltages. The gate lines and data lines cooperatively define a plurality of pixel regions in the form of a matrix. Each pixel region includes a first pixel electrode and a second pixel electrode. The first and second pixel electrodes are applied with different gray scale voltages.

Other novel features, advantages and aspects will become more apparent from the following detailed description when taken in conjunction with the accompanying drawings.

### BRIEF DESCRIPTION OF THE DRAWINGS

FIG. 1 is a circuit diagram of part of a multi-domain vertical alignment mode liquid crystal display according to an exemplary embodiment of the present invention, the liquid crystal display including a plurality of pixel regions.

FIG. 2 is an enlarged circuit diagram of one of the pixel regions of FIG. 1.

FIG. 3 is a timing diagram of driving signals applied to the pixel region of FIG. 2.

FIG. 4 is a circuit diagram of part of a conventional multi-domain vertical alignment mode liquid crystal display, the liquid crystal display including a plurality of pixel regions.

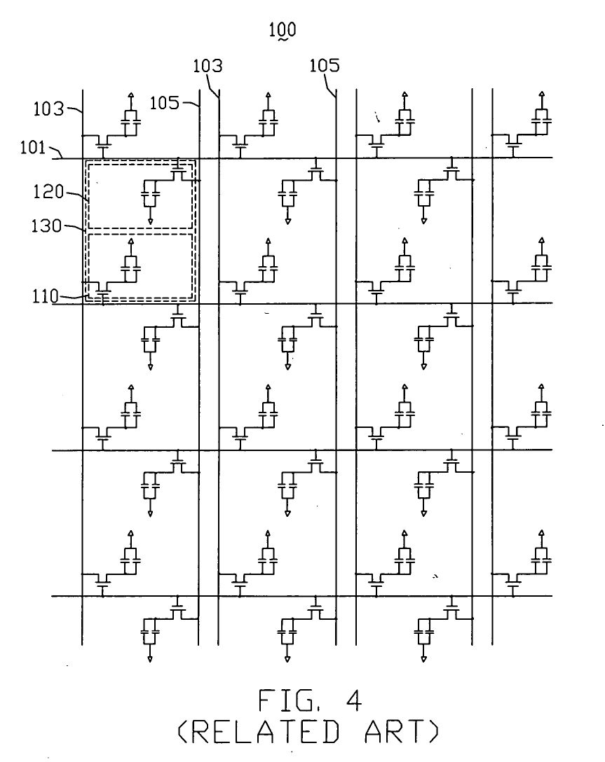

FIG. 5 is an enlarged circuit diagram of one of the pixel regions of FIG. 4.

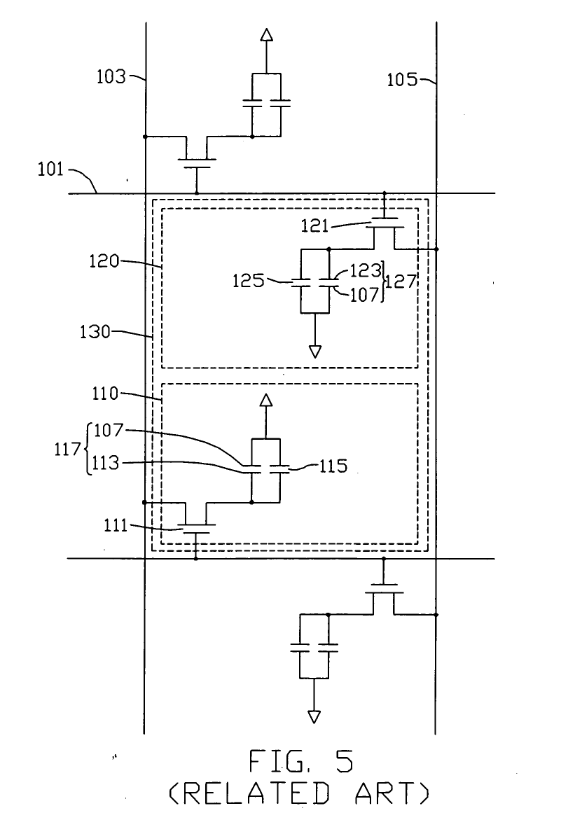

### DETAILED DESCRIPTION OF PREFERRED EMBODIMENTS

Reference will now be made to the drawings to describe preferred and exemplary embodiments in detail.

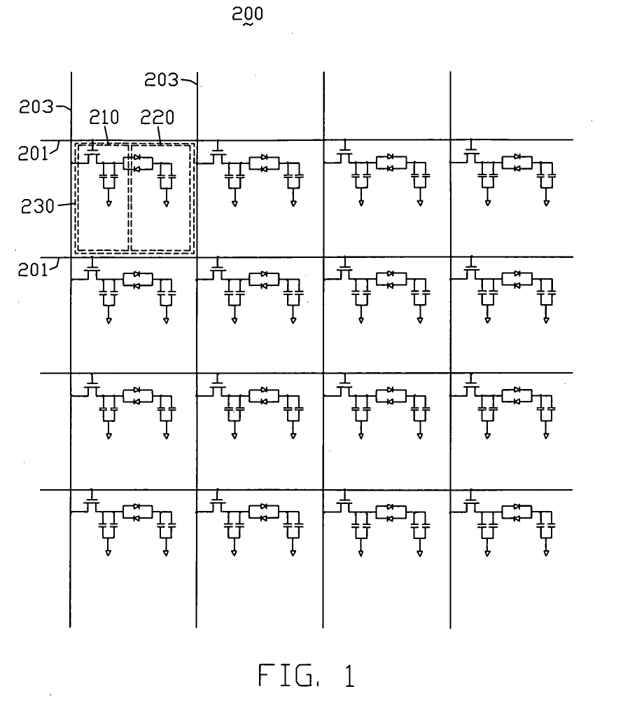

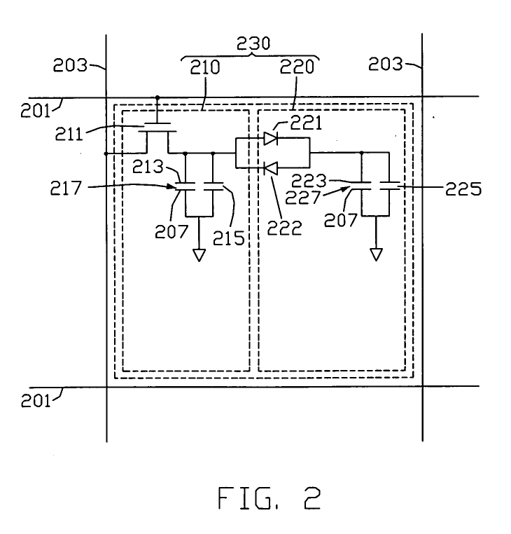

Referring to FIG. 1 and FIG. 2, part of a multi-domain vertical alignment mode LCD 200 according to an exemplary embodiment of the present invention is shown. In this description, the multi-domain vertical alignment mode LCD 200 is also referred to as a “multi-domain vertical alignment LCD 200.” The multi-domain vertical alignment LCD 200 includes a plurality of gate lines 201 parallel to each other, a plurality of data lines 203 parallel to each other and orthogonal to the gate lines 201, a plurality of TFTs 211, a plurality of first pixel electrodes 213, a plurality of second pixel electrodes 223, a plurality of first storage capacitors 215, a plurality of second storage capacitors 225, a plurality of first diodes 221, and a plurality of second diodes 222.

A smallest area defined by adjacent two data lines 203 and two adjacent gate lines 201 is defined as a pixel 230. Each pixel 230 includes a first sub-pixel 210 and a second sub-pixel 220. As shown in FIG. 2, one TFT 211, one first pixel electrode 213, one common electrode 207, and one first storage capacitor 215 cooperatively define the first sub-pixel 210. One first diode 221, one second diode 222, one second pixel electrode 223, one common electrode 207, and one second storage capacitor 225 cooperatively define the second sub-pixel 220. The first sub-pixel 210 essentially corresponds to part of a display area of the pixel 230, and the second sub-pixel 220 corresponds to another part of the display area of the pixel 230.

Each TFT 211 includes a gate electrode (not labeled) connected to a corresponding gate line 201, a source electrode (not labeled) connected to a corresponding data line 203, and a drain electrode (not labeled) connected to a corresponding first pixel electrode 213. The first pixel electrode 213 and the corresponding common electrode 207 constitute a first liquid crystal capacitor 217. The first storage capacitor 215 and the first liquid crystal capacitor 217 are connected in parallel. The drain electrode of the TFT 211 is further connected to the anode of the first diode 221 and the cathode of the second diode 222. The cathode of the first diode 221 is connected to the corresponding second pixel electrode 223. The anode of the second diode 222 is connected to the corresponding second storage capacitor 225. The second pixel electrode 223 and the corresponding common electrode 207 constitute a second liquid crystal capacitor 227. The second storage capacitor 225 and the second liquid crystal capacitor 227 are connected in parallel.

The gate lines 201 are configured for applying a plurality of scanning signals to the TFTs 211 in order to switch on or switch off the TFTs 211. The data lines 203 are configured for applying a plurality of gray scale voltages to the gate electrodes of the TFTs 211 when the TFTs 211 are switched on. The TFTs 211 are switched on when receiving high-level scanning signals, and are switched off when receiving low-level scanning signals. The common electrodes 207 are provided with a predetermined common voltage Vcom.

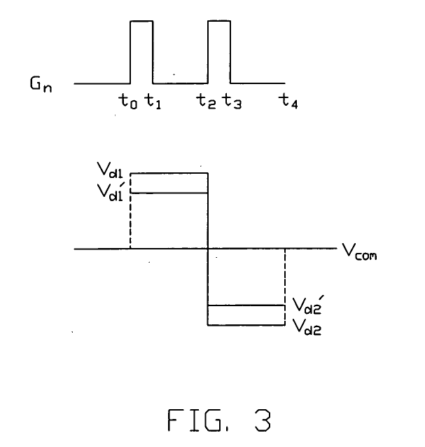

Referring also to FIG. 3, part of an abbreviated waveform illustrating driving of the liquid crystal display 200 is shown. Gn represents a timing chart showing exemplary waveforms of scanning signals applied to one of the pixels 230. Vd1 and Vd2 represent gray scale voltages applied to the first sub-pixel 210 of the pixel 230 during two adjacent frames respectively. Vd1′ and Vd2′ represent gray scale voltages applied to the second sub-pixel 220 of the pixel 230 in the two adjacent frames respectively.

In the period t0˜t1, one of the gate lines 203 is applied with the scanning signal. The scanning signal is a high-level voltage in the t0˜t1 period, and the corresponding TFTs 211 that are electrically connected to the gate line 203 are switched on. The gray scale voltage Vd1 is applied to the first pixel electrode 213. Moreover, the gray scale voltage Vd1 is further applied to the second pixel electrode 223 via the anode and the cathode of the first diode 221 with a voltage drop. That is, the gray scale voltage Vd1′ is applied to the second pixel electrode 223 (see FIG. 3). The voltage drop is caused by the first diode 221. A value of the voltage drop is approximately determined by an inherent resistance of the first diode 221, and is usually about 0.7V. The second diode 222 is charged by the gray scale voltage Vd1′. The gray scale voltages Vd1 and Vd1′ are greater than the common voltage Vcom.

In the t1˜t2 period, the scanning signal jumps to a low-level voltage, thus the TFTs 211 are switched off. Because of the discharging of the first storage capacitor 215 and the second storage capacitor 225, the first pixel electrode 213 and the second pixel electrode 223 maintain the gray scale voltages Vd1, Vd1′ respectively.

In the t2˜t3 period, the scanning signal jumps to a high-level voltage again. The TFTs 211 are switched on. The gray scale voltage Vd2 is applied to the first pixel electrode 213 via the source electrode and drain electrode of the TFT 211. The gray scale voltage Vd2 is further applied to the second pixel electrode 223 via the negative and anodes of the second diode 222. The first liquid crystal capacitor 217 and the first storage capacitor 215 both discharge through the drain electrode and the source electrode of the TFT 211. The second liquid crystal capacitor 227 and the second storage capacitor 225 discharge through the second diode 222, the drain electrode and the source electrode. Because the second diode 222 has an inherent resistance, the gray scale voltage Vd2′ is approximately 0.7V greater than the gray scale voltage Vd2. The gray scale voltage Vd2 is still less than the common voltage Vcom.

In the t3˜t4 period, the scanning signal jumps to a low-level voltage again. The first pixel electrode 213 and the second pixel electrode 223 maintain the gray scale voltages Vd2, Vd2′ in the t3˜t4 period.

Generally, the t0˜t2 period is known as a frame, and so is the t2˜t4 period. After t4, the pixel 230 is driven by the scanning signals in a regular, repeating pattern. That is, after t4, the procedure of driving the pixel 230 repeats the above-described driving procedure for t0˜t4 period.

In summary, because of the first and second diodes 221, 222, the gray scale voltages applied to the first sub-pixel 210 differ from the gray scale voltages applied to the corresponding second sub-pixel 220 in each frame. Thus, the liquid crystal display 200 can reduce or even eliminate any color shift that may otherwise occur.

Other alternative embodiments can include the following. In one example, the first and second diodes 221, 222 can instead be any suitable electrical elements that employ a unidirectional current breakdown function.

It is to be further understood that even though numerous characteristics and advantages of the present embodiments have been set out in the foregoing description, together with details of the structures and functions of the embodiments, the disclosure is illustrative only; and that changes may be made in detail, especially in matters of shape, size, and arrangement of parts within the principles of the invention to the full extent indicated by the broad general meaning of the terms in which the appended claims are expressed.

What is claimed is:

1. A multi-domain vertical alignment mode liquid crystal display comprising:
a plurality of gate lines configured for providing a plurality of scanning signals; and
a plurality of data lines configured for providing a plurality of gray scale voltages, the gate lines and data lines cooperatively defining a plurality of pixel regions arranged in a matrix, each pixel region comprising a thin film transistor, a first pixel electrode, and a second pixel electrode;
wherein the first and second pixel electrodes are both electrically connected to one corresponding data line via the thin film transistor; and
the gray scale voltages applied to the first and second electrodes are different from each other.

2. The liquid crystal display in claim 1, further comprising a plurality of first diodes and a plurality of second diodes, the first pixel electrode being connected to the second pixel electrode via an anode and a cathode of the first diode, and further connected to the second pixel electrode via a cathode and an anode of the second diode.

3. The liquid crystal display in claim 1, wherein each thin film transistor comprises a gate electrode connected to the gate line, a source electrode connected to data line, and a drain electrode connected to the first pixel electrode.

4. The liquid crystal display in claim 1, further comprising a plurality of common electrodes, the first pixel electrode and the corresponding common electrode constituting a first liquid crystal capacitor, the second pixel electrode and the corresponding common electrode constituting a second liquid crystal capacitor.

5. The liquid crystal display in claim 4, further comprising a plurality of first and second storage capacitors, the first storage capacitors and the first liquid crystal capacitors being connected in parallel, the second storage capacitors and the second liquid crystal capacitors being connected in parallel.

6. The liquid crystal display in claim 5, wherein the gate lines are parallel to each other, and the data lines are parallel to each other and orthogonal to the gate liens.

7. The liquid crystal display in claim 1, wherein the gray scale voltages applied to the first and second pixel electrodes have a difference of 0.7V.

8. The liquid crystal display in claim 4, wherein the common electrodes are applied with a predetermined common voltage.

9. The liquid crystal display in claim 8, wherein when the gray scale voltage provided by the data line is above the predetermined common voltage, the gray scale voltage applied to the first pixel electrode is 0.7V more than the gray scale voltage applied to the second pixel electrode; when the gray scale voltage provided by the data line is below the predetermined common voltage, the gray scale voltage applied to the first pixel electrode is 0.7V less than the gray scale voltage applied to the second pixel electrode.

10. The liquid crystal display in claim 5, wherein when the scanning signal is applied to the pixel region, the gray scale voltage being applied to the pixel region, the first and second storage capacitors of the pixel region are charged or discharged simultaneously.

11. A multi-domain vertical alignment mode liquid crystal display comprising:
a plurality of gate lines configured for providing a plurality of scanning signals;
a plurality of data lines configured for providing a plurality of gray scale voltages, wherein the gate lines and data lines cooperatively define a plurality of pixel regions arranged in a matrix, each pixel region comprising:
a first sub-pixel region comprising a thin film transistor configured to be switched on to transmit gray scale voltages, and a first pixel electrode; and
a second sub-pixel region comprising a second pixel electrode, a first diode, and a second diode, wherein the first pixel electrode is connected to the second pixel electrode via two branches in parallel, one of the branches comprising the anode and the cathode of the first diode, and the other branch comprising the cathode and the anode of the second diode.

12. The liquid crystal display in claim 11, wherein the pixel region further comprises two common electrodes corresponding to the first pixel electrode and the second pixel electrode.

13. The liquid crystal display in claim 12, wherein the first pixel electrode and the corresponding common electrode substantially constitute a first liquid crystal capacitor, and the second pixel electrode and the corresponding common electrode substantially constitute a second liquid crystal capacitor.

14. The liquid crystal display in claim 13, wherein the pixel region further comprises a first storage capacitor and a second storage capacitor, the first storage capacitor and the first liquid crystal capacitor being connected in parallel, the second storage capacitor and the second liquid crystal capacitor being connected in parallel.

15. The liquid crystal display in claim 12, wherein the common electrodes are applied with a predetermined common voltage.

16. The liquid crystal display in claim 11, wherein the thin film transistor comprises a gate electrode connected to the gate line, a source electrode connected to the data line, and a drain electrode connected to the drain electrode.

17. A multi-domain vertical alignment mode liquid crystal display comprising:
a plurality of first sub-pixels;
a plurality of second sub-pixels corresponding to the first sub-pixels, and
a plurality of thin film transistors corresponding to the first sub-pixels;
wherein one first sub-pixel, one corresponding thin film transistor, and one corresponding second sub-pixel cooperatively constitute a pixel and the pixels are formed in a matrix, the first sub-pixel and the corresponding second sub-pixel of one pixel being loaded with different pixel voltages.
